(19) United States
(12) Patent Application Publication
(10) Pub. No.: US 2006/0202745 A1
(43) Pub. Date: Sep. 14, 2006

(54) Reference voltage generating circuit and reference current generating circuit

(75) Inventors: Kazuyuki Kobayashi, Yamada-gun (JP); Tatsuya Suzuki, Kumagaya-shi (JP); Yasuhiro Kaneta, Isezaki-shi (JP)

Correspondence Address: OLIFF & BERRIDGE, PLC, P.O. BOX 19928, ALEXANDRIA, VA, 22320, US

(73) Assignee: SANYO ELECTRIC CO., LTD., MORIGUCHI-SHI (JP)

(21) Appl. No.: 11/366,745

(22) Filed: Mar. 3, 2006

(30) Foreign Application Priority Data
Mar. 8, 2005 (JP) 2005-064520
Jan. 30, 2006 (JP) 2006-020023

(51) Int. Cl. G05F 1/10

(52) U.S. Cl. 327/541

(57) ABSTRACT

In a reference current generating circuit, an output voltage of a regulator is divided by a resistance dividing circuit consisting of resistors to generate a micro reference voltage. It is possible to connect and disconnect the resistance dividing circuit using a switch consisting of a transistor. A switch consisting of a transistor is provided between a connection point of the resistors and a reference voltage output terminal. A capacitor is connected to the reference voltage output terminal. The transistors are periodically subjected to ON/OFF control according to a clock pulse outputted by a control circuit. The capacitor is charged to a reference voltage when the transistors are on and keeps the reference voltage output terminal at the reference voltage when the transistors are off. A current mirror circuit uses the micro reference voltage to generate a micro reference current while suppressing an increase in a resistance of a reference resistor that determines an output current. With this constitution, it is possible to reduce an area of the reference resistor in the reference current generating circuit constituted as a semiconductor integrated circuit.

### CROSS-REFERENCE TO RELATED APPLICATIONS

The priority application numbers JP2005-064520 and JP2006-020023 upon which this patent application is based are hereby incorporated by reference.

### BACKGROUND OF THE INVENTION

1. Field of the Invention

The present invention relates to a reference voltage generating circuit and a reference current generating circuit that generate a voltage and an electric current used as references in the operation of other circuits and the like, respectively, and, more particularly to a circuit that generates a micro reference voltage or a micro reference current at low power consumption.

2. Description of the Related Art

FIG. 1 is a circuit diagram showing a constitution of a conventional circuit that generates a predetermined current used as a reference in the operation of an electronic circuit (a reference current). The circuit is integrated on a semiconductor substrate. The circuit includes a current mirror circuit 2 and an operational amplifier A. The current mirror circuit 2 generates a reference current on the basis of a reference voltage Vref. The operational amplifier A is provided for impedance conversion between a supply source of the reference voltage Vref and the current mirror circuit 2. As operation power supplies for the current mirror circuit 2 and the operational amplifier A, a ground GND and a power supply Vcc that supplies a predetermined positive voltage are used. The reference voltage Vref is set to, for example, 1.2V. The reference voltage Vref is generated by the supply source such as a regulator and supplied.

The current mirror circuit 2 includes MOS transistors Q1 and Q2 and a reference resistor Rref. Both gates of the MOS transistors Q1 and Q2 are connected to an output terminal of the operational amplifier A. Sources of the MOS transistors Q1 and Q2 are connected to the power supply Vcc. A drain of the MOS transistor Q1 is connected to a non-inverting input terminal of the operational amplifier A. This means that the gate and the drain of the MOS transistor Q1 are connected to each other via the operational amplifier A. The reference resistor Rref is connected between the drain of the MOS transistor Q1 and the ground GND.

The reference voltage Vref is inputted to an inverting input terminal of the operational amplifier A. As described above, the gate of the MOS transistor Q1 is connected to the output terminal of the operational amplifier A. The drain of the MOS transistor Q1 and the reference resistor Rref are connected to the non-inverting input terminal of the operational amplifier A. Virtual short-circuit is formed between both the input terminals of the operational amplifier A. Thus, a voltage at the non-inverting input terminal is basically equal to the reference voltage Vref inputted to the inverting input terminal.

The reference resistor Rref is applied with the reference voltage Vref at the non-inverting input terminal and generates a reference current Iref corresponding to the reference voltage Vref. The reference current Iref is inputted to a current mirror circuit as an input current. An output current corresponding to the reference current Iref is outputted from a drain of the MOS transistor Q2 on the output side of the current mirror circuit.

In this way, a magnitude of the reference current Iref depends on magnitudes of the reference voltage Vref and a resistance of the reference resistor Rref. Thus, a value of the resistance of the reference resistor Rref is set large when it is necessary to generate a micro reference current Iref according to a given reference voltage Vref.

A temperature characteristic of the reference current Iref is affected by a temperature characteristic of the reference resistor Rref. Thus, in designing the reference resistor Rref, consideration should be given to the design to make temperature dependency of the reference resistor Rref low. When an integrated circuit is formed, usually, a resistor is formed using a diffusion layer or polysilicon. The polysilicon is used for formation of the reference resistor Rref because of a relatively satisfactory temperature characteristic thereof.

On the other hand, the polysilicon has a low sheet resistance. Therefore, when it is attempted to increase the resistance of the reference resistor Rref in order to generate the micro reference current Iref, a resistance element formed of the polysilicon occupies a large area on a semiconductor substrate to cause an increase in a chip size and an increase in cost.

If it is possible to reduce a reference voltage inputted to the operational amplifier A to a micro value, it is also possible to generate the micro reference current Iref. There is resistance division as a simple method of generating a new reference voltage equal to or lower than, for example, about several hundreds millivolts on the basis of a voltage output of about 1V to several volts that a usual voltage regulator circuit can generate.

When a new micro reference voltage is generated by a resistance dividing circuit, power consumption increases because of an electric current flowing to the resistance dividing circuit.

### SUMMARY OF THE INVENTION

The invention has been devised in view of the problems and it is an object of the invention to provide a reference voltage generating circuit that is capable of generating a micro reference voltage while controlling power consumption and a reference current generating circuit that is capable of generating a micro reference current while controlling a magnitude of a reference resistance.

A reference voltage generating circuit according to the invention includes: two voltage sources that generate predetermined voltages, respectively; a voltage dividing circuit that is connected between the two voltage sources, periodically divides a voltage generated between both the voltage sources, and outputs a divided voltage from a divided voltage output terminal; an output capacitor, one terminal of which is connected to the divided voltage output terminal and a reference voltage output terminal; a charging switch inserted between the output capacitor and the divided voltage output terminal; and a charge control circuit that turns on the charging switch in association with the output of the divided voltage of the voltage dividing circuit and charges the output capacitor. The reference voltage generating circuit outputs a reference voltage corresponding to the divided voltage from the reference voltage output terminal.

### BRIEF DESCRIPTION OF THE DRAWINGS

In the accompanying drawings:

FIG. 1 is a circuit diagram showing a constitution of the conventional reference current generating circuit;

FIG. 2 is a circuit diagram showing a schematic constitution of a reference current generating circuit according to a first embodiment of the invention;

FIG. 3 is a circuit diagram showing a schematic constitution of a reference current generating circuit according to a second embodiment of the invention;

FIG. 4A is a circuit diagram schematically showing a series constitution of a capacitor realized by switching of MOS transistors Q5 to Q11; and

FIG. 4B is a circuit diagram schematically showing a parallel constitution of the capacitor realized by switching of the MOS transistors Q5 to Q11.

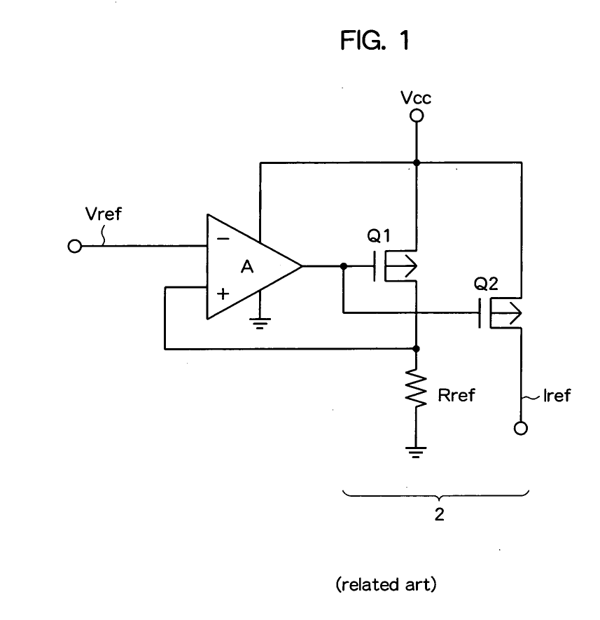

### DESCRIPTION OF THE PREFERRED EMBODIMENTS

Embodiments of the invention will be hereinafter explained with reference to the accompanying drawings.

### FIRST EMBODIMENT

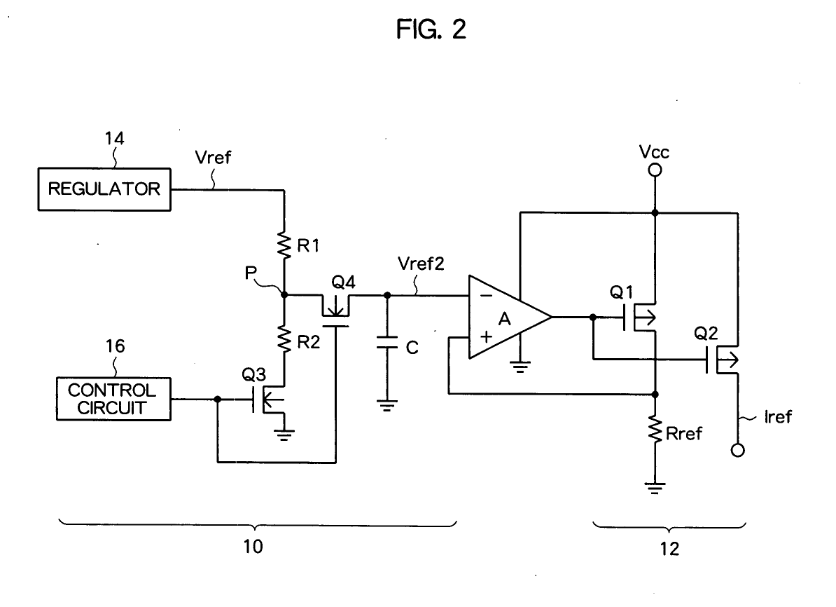

FIG. 2 is a circuit diagram showing a schematic constitution of a reference current generating circuit according to a first embodiment of the invention. The reference current generating circuit is integrated on a semiconductor substrate. The reference current generating circuit includes a reference voltage generating circuit 10, a current mirror circuit 12, and an operational amplifier A. The reference voltage generating circuit 10 generates a micro reference voltage Vref2. The current mirror circuit 12 generates a reference current on the basis of the reference voltage Vref2. The operational amplifier A is provided for impedance conversion between the reference voltage generating circuit 10 and the current mirror circuit 12.

A ground GND and a power supply Vcc that supplies a predetermined positive voltage are used as operation power supplies for the current mirror circuit 12 and the operational amplifier A. The reference voltage generating circuit 10 includes a regulator 14 and a ground GND as reference power supplies. The reference voltage generating circuit 10 generates the reference voltage Vref2 anew on the basis of an output voltage Vref of the regulator 14 and outputs the reference voltage Vref2.

The reference voltage generating circuit 10 includes, other than the regulator 14, resistors R1 and R2, MOS transistors Q3 and Q4, a capacitor C, and a control circuit 16.

The resistor R1 and the resistor R2 are connected in series and form a current path between an output terminal of the regulator 14 and the ground GND. The MOS transistor Q3 is inserted in the current path and functions as a switch for performing connection and disconnection of the current path. For example, one terminal of the resistor R1 is connected to the regulator 14 and the other terminal of the resistor R1 is connected to one terminal of the resistor R2. The other terminal of the resistor R2 is connected to a drain of the MOS transistor Q3 and a source of the MOS transistor Q3 is connected to the ground GND. A gate of the MOS transistor Q3 is connected to an output terminal of the control circuit 16. The resistors R1 and R2, the MOS transistor Q3, and the control circuit 16 function as a voltage dividing circuit that divides a voltage between the regulator 14 and the ground GND.

One terminal of the capacitor C is connected to a connection point P of the resistor R1 and the resistor R2 via the MOS transistor Q4 and is also connected to an output terminal of the reference voltage generating circuit 10. The other terminal of the capacitor C is grounded to the ground GND. For example, a drain and a source of the MOS transistor Q4 are connected to the connection point P and the capacitor C, respectively. The MOS transistor Q4 functions as a charging switch that performs connection and disconnection of the capacitor C and the connection point P. A gate of the MOS transistor Q4 is connected to the output terminal of the control circuit 16.

The control circuit 16 generates a clock pulse at a predetermined period and applies the clock pulse to the gates of the MOS transistors Q3 and Q4. Both the MOS transistors Q3 and Q4 perform ON/OFF operations in synchronization with a rising edge and a falling edge of this pulse.

Specifically, the MOS transistors Q3 and Q4 are on in a period in which the clock pulse is applied thereto. When the MOS transistor Q3 is turned on, an electric current corresponding to the output voltage Vref flows to the resistors R1 and R2. A voltage Vp obtained by dividing the output voltage Vref according to resistances of the resistors R1 and R2 is generated at the connection point P. The voltage Vp is given by the following expression.
Vp=Vref*R2/(R1+R2)

When the MOS transistor Q4 is turned on, the capacitor C is applied with the voltage Vp and charged such that an inter-terminal voltage thereof is equal to the voltage Vp.

On the other hand, in a period in which the clock pulse is not applied, the MOS transistors Q3 and Q4 are off. When the MOS transistor Q3 is turned off, an electric current does not flow to the resistors R1 and R2. When the MOS transistor Q4 is turned off, the capacitor C is separated from the connection point P.

In the operations described above, in the period in which the clock pulse is applied, the output voltage Vref2 of the reference voltage generating circuit 10 is equal to the voltage Vp given from the connection point P. In the period in which the clock pulse is not applied, the output voltage Vref2 is basically equal to the voltage Vp because of a voltage held by the capacitor C. In other words, the reference voltage generating circuit 10 outputs the reference voltage Vref2 that is kept constant.

A value of the reference voltage Vref2 is set according to values of resistances of the resistors R1 and R2. For example, when a resistance of the resistor R1 is set to a value nine times as large as that of the resistor R2, it is possible to reduce the reference voltage Vref2 to 1/10 of the output voltage Vref. The output voltage Vref of the regulator 14 is set to, for example, about 1V to about several volts. For example, when the regulator 14 outputs 1.2V and the output voltage is subjected to resistance division to be reduced to 1/10 by the resistors R1 and R2, the reference voltage Vref2 outputted by the reference voltage generating circuit 10 is 0.12V. In this way, the reference voltage generating circuit 10 generates the micro reference voltage Vref2 on the basis of a voltage generated by a usual regulator and outputs the micro reference voltage Vref2.

As described above, in the reference voltage generating circuit 10, the micro reference voltage Vref2 is generated according to resistance division. However, an electric current only flows intermittently between the resistors R1 and R2. Consequently, power consumption is reduced in this resistance dividing circuit section.

The reference voltage Vref2 generated is transmitted to the current mirror circuit 12 via the operational amplifier A. Since an input impedance of the operational amplifier A is high, electric discharge of the capacitor C is suppressed. Since the control circuit 16 periodically generates a clock pulse, the capacitor C is recharged at a predetermined period. Thus, the capacitor C can maintain the inter-terminal voltage at the voltage Vp with satisfactory accuracy.

The current mirror circuit 12 includes MOS transistors Q1 and Q2 and a reference resistor Rref. Both gates of the MOS transistors Q1 and Q2 are connected to an output terminal of the operational amplifier A. Sources of the MOS transistors Q1 and Q2 are connected to the power supply Vcc. A drain of the MOS transistor Q1 is connected to a non-inverting input terminal of the operational amplifier A. In other words, the gate and the drain of the MOS transistor Q1 are connected to each other via the operational amplifier A. The reference resistor Rref is connected between the drain of the MOS transistor Q1 and the ground GND.

The output voltage Vref2 of the reference voltage generating circuit 10 is inputted to an inverting input terminal of the operational amplifier A. As described above, the gate of the MOS transistor Q1 is connected to the output terminal of the operational amplifier A. The drain of the MOS transistor Q1 and the reference resistor Rref are connected to the non-inverting input terminal of the operational amplifier A. Virtual short-circuit is formed between both the input terminals of the operational amplifier A. Thus, a voltage at the non-inverting input terminal is basically equal to the output voltage Vref2 inputted to the inverting input terminal.

The reference resistor Rref is applied with the voltage Vref2 at the non-inverting input terminal and generates a reference current Iref corresponding to the output voltage Vref. The reference current Iref is inputted to a current mirror circuit as an input current. An output current corresponding to the reference current Iref is outputted from a drain of the MOS transistor Q2 on the output side of the current mirror circuit.

In this way, a magnitude of the reference current Iref depends on magnitudes of the reference voltage Vref2 and a resistance of the reference resistor Rref. Specifically, the reference current Iref is proportional to the reference voltage Vref2 and inversely proportional to the resistance of the reference resistor Rref. As described above, the reference voltage generating circuit 10 can set the reference voltage Vref2 to a micro value. Thus, it is possible to generate the micro reference current Iref while suppressing and preventing an increase in a value of the resistance of the reference resistor Rref. Since it is possible to set a value of the resistance of the reference resistor Rref small, even if a resistance element having the resistance of the reference resistor Rref is formed using polysilicon, a temperature characteristic of which is satisfactory but a sheet resistance of which is relatively small, an increase in an area of the resistance element on a semiconductor substrate is prevented. This makes it possible to cut down a chip size and cost.

In the constitution described above, the MOS transistors Q3 and Q4 perform a switch operation according to a common clock pulse from the control circuit 16 to stay on in the same period. On the other hand, it is also possible to adopt a constitution in which, for example, a current path control circuit that supplies a clock pulse to the gate of the MOS transistor Q3 and a charge control circuit that supplies a clock pulse to the gate of the MOS transistor Q4 are separately provided and the MOS transistors Q3 and Q4 perform the switch operation according to different clock pulses. In that case, a period in which the MOS transistor Q4 is on may be included in a period in which the MOS transistor Q3 is on. Consequently, after a voltage at the connection point P is set according to turning-on of the MOS transistor Q3, the capacitor C is connected to the connection point P. On the other hand, after the capacitor C is separated from the connection point P, an electric current flowing to the resistance dividing circuit is stopped. Thus, a stable voltage at the connection point P is applied to the capacitor C.

In the constitution described above, the control of an electric current flowing through the resistors R1 and R2 constituting the resistance dividing circuit is performed according to connection and disconnection of a switch constituted by the MOS transistor Q3. However, a constitution for the control of an electric current flowing through the resistors R1 and R2 is not limited to this constitution. Other control means for periodically turning on and off an electric current flowing through the resistors R1 and R2 may be adopted. For example, a voltage output itself of the regulator 14 may be turned on and off.

### SECOND EMBODIMENT

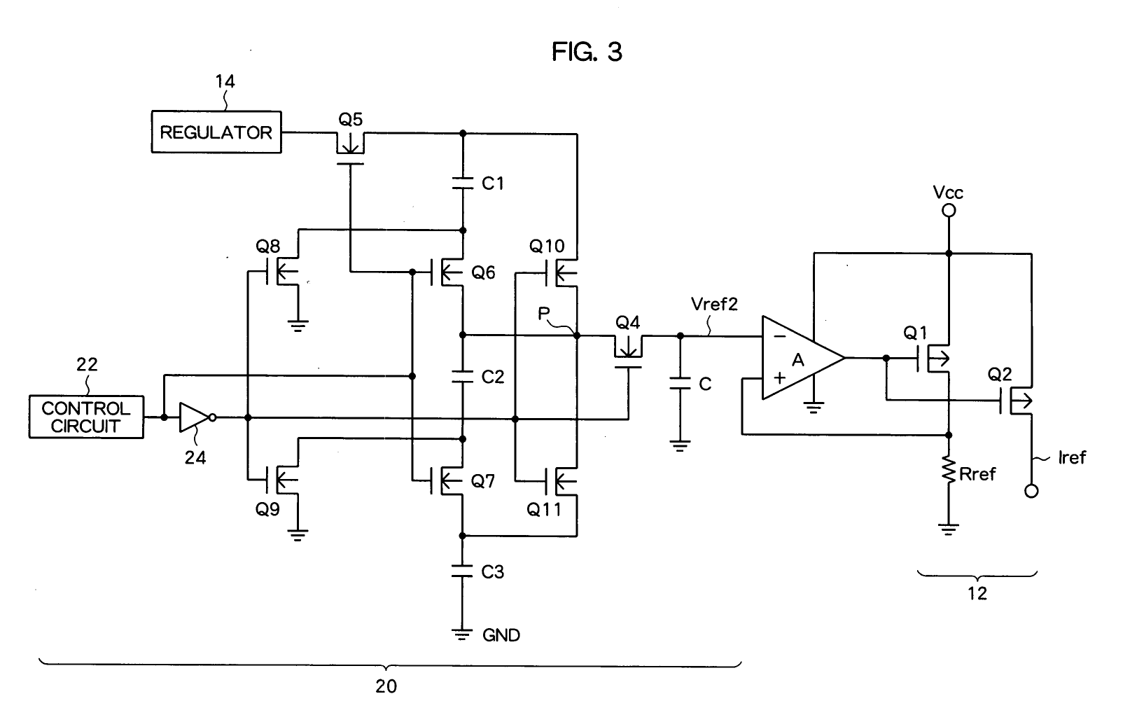

FIG. 3 is a circuit diagram showing a schematic constitution of a reference current generating circuit according to a second embodiment of the invention. The reference current generating circuit is integrated on a semiconductor substrate in the same manner as the reference current generating circuit in the first embodiment. The reference current generating circuit is different from the reference current generating circuit in the first embodiment in a constitution of a voltage dividing circuit that generates the divided voltage Vp in a reference voltage generating circuit. Otherwise, the reference current generating circuit can basically adopt a constitution identical with that of the reference current generating circuit in the first embodiment. To facilitate understanding of characteristics of the reference current generating circuit, in the following explanation, components identical with those in the reference current generating circuit in the first embodiment are denoted by the identical reference numerals and signs. The explanations concerning the first embodiment are applied to explanations of this embodiment to simplify the explanations.

The reference current generating circuit in this embodiment includes a reference voltage generating circuit 20 that generates the micro reference voltage Vref2, the current mirror circuit 12 that generates a reference current on the basis of the reference voltage Vref2, and the operational amplifier A provided for impedance conversion between the reference voltage generating circuit 20 and the current mirror circuit 12.

The reference voltage generating circuit 20 includes the regulator 14 and the ground GND as voltage sources. The reference voltage generating circuit 20 generates the reference voltage Vref2 anew on the basis of the output voltage Vref of the regulator 14 and outputs the reference voltage Vref2.

Like the reference voltage generating circuit 10, the reference voltage generating circuit 20 includes the MOS transistor Q4 and the capacitor C. Moreover, the reference voltage generating circuit 20 includes, as components of the voltage dividing circuit, three capacitors C1 to C3, MOS transistors Q5 to Q11, a control circuit 22, and an inverter 24. The MOS transistors Q5 to Q11 are a group of switches for setting a connection relation of the capacitors C1 to C3 to organize the reference voltage generating circuit 20. The MOS transistors Q5 to Q11 change a conduction state between sources and drains thereof according to a gate voltage and switch connection and disconnection between wiring connected to the sources and wiring connected to the drains. The control circuit 22 controls on and off of the MOS transistors Q5 to Q11 according to the gate voltage and selectively forms series connection and parallel connection of the capacitors C1 to C3.

A series constitution and a parallel constitution of the capacitors C1 to C3 will be hereinafter specifically explained. The MOS transistor Q5 controls connection and disconnection between the regulator 14 and the capacitor C1. The MOS transistor Q6 controls connection and disconnection between the capacitor C1 and the capacitor C2. The MOS transistor Q7 controls connection and disconnection between the capacitor C2 and the capacitor C3.

The MOS transistor Q8 controls connection and disconnection of a terminal of the capacitor C1 connected to the MOS transistor Q6 and the ground GND. The MOS transistor Q9 controls connection and disconnection between a terminal of the capacitor C2 connected to the MOS transistor Q7 and the ground GND.

The MOS transistor Q10 controls connection and disconnection between a terminal of the capacitor C1 connected to the MOS transistor Q5 and the connection point P. The MOS transistor Q11 controls connection and disconnection between a terminal of the capacitor C3 connected to the MOS transistor Q7 and the connection point P. A terminal of the capacitor C2 connected to the MOS transistor Q6 is also connected to the connection point P.

For example, the MOS transistors Q4 to Q11 are n-MOS transistors. The MOS transistors Q4 to Q11 are turned on when a predetermined High (H) level voltage is applied to the gates thereof and turned off when a predetermined Low (L) level voltage is applied to the gates. The control circuit 22 outputs the H level and L level voltages. The inverter 24 inverses a voltage level of a voltage inputted from the control circuit 22 and outputs the voltage. The MOS transistors Q5 to Q7 are directly applied with the output of the control circuit 22 at the gates thereof. On the other hand, the MOS transistors Q4 and Q8 to Q11 are applied with the output of the inverter 24 at the gates thereof.

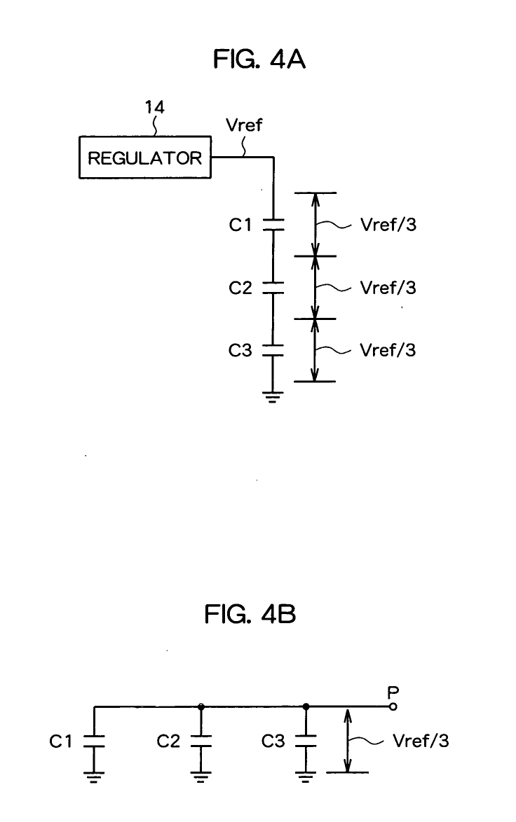

In a period in which the control circuit 22 outputs the H level voltage, the MOS transistors Q5 to Q7 are turned on and the series connection of the capacitors C1 to C3 is formed between the regulator 14 and the ground GND. FIG. 4A is a circuit diagram schematically showing the series constitution of the capacitors C1 to C3 formed between the regulator 14 and the ground GND. For example, it is possible to set capacitances of the capacitors C1 to C3 to the same value. In that case, the capacitors C1 to C3 are charged to an inter-terminal voltage as high as ⅓ of the voltage difference Vref between the regulator 14 and the ground GND, respectively. At this point, the MOS transistor Q4 is off and the capacitor C and the capacitors C1 to C3 are separated. Thus, the capacitor C basically maintains a charging voltage that has been applied thereto.

The control circuit 22 outputs the L level voltage after outputting the H level voltage. In a period in which the control circuit 22 outputs the L level voltage, the MOS transistors Q5 to Q7 are off and the MOS transistors Q4 and Q8 to Q11 are on. In this state, one terminals of the capacitors C1 to C3 are connected the connection point P and the other terminals thereof are connected to the ground GND. In other words, the capacitors C1 to C3 are connected in parallel to one another between the connection point P and the ground GND. FIG. 4B is a circuit diagram schematically showing the parallel constitution of the capacitors C1 to C3 formed between the connection point P and the ground GND. Since the capacitors C1 to C3 are connected in parallel while basically holding charges charged at the time of the series connection, the voltage Vp at the connection point P is equal to Vref/3. As described above, it is possible to divide a supply voltage of the regulator 14 by switching the series connection of the capacitors C1 to C3 to the parallel connection. At the time of the parallel connection, the MOS transistor Q4 is on and the capacitor C is connected to the connection point P to be charged such that an inter-terminal voltage thereof is equal to the voltage Vp.

According to the operations described above, in the period in which an output of the control circuit 22 is the L level voltage, the output voltage Vref2 of the reference voltage generating circuit 20 is equal to the voltage Vp given from the connection point P. In the period in which an output of the control circuit 22 is the H level voltage, the output voltage Vref2 is basically equal to the voltage Vp because of a voltage held by the capacitor C. In other words, the reference voltage generating circuit 20 outputs the reference voltage Vref2 that is kept constant.

The control circuit 22 alternately generates the H level voltage and the L level voltage to periodically repeat the operations described above. Consequently, a state of charge of the capacitor C is refreshed, a voltage change of the capacitor C due to a leak current or the like is controlled, and the reference voltage Vref2 is satisfactorily kept constant.

In the constitution described above, the number of plural capacitors connected to one another is not limited to three. It is possible to set the number to an arbitrary value. Capacitances of the capacitors do not always have to be equal. A value of the reference voltage Vref2 is set according to the number of capacitors and capacitances thereof. For example, it is possible to constitute the reference voltage generating circuit 20 in which the reference voltage Vref2 is 1/m of the output voltage Vref using m capacitors having capacitances equal to one another. In other words, the reference voltage generating circuit 20 is capable of generating the micro reference voltage Vref2 on the basis of a voltage generated by a usual regulator and outputting the micro reference voltage Vref2.

When the capacitors are connected in series in the reference voltage generating circuit 20, an electric current flows from the regulator 14 until the respective capacitors are charged to reach a saturated state. After the capacitors reach the saturated state, basically, an electric current does not flow. Thus, a voltage dividing circuit using the capacitors of the reference voltage generating circuit 20 can cut down power consumption.

The reference voltage Vref2 generated is applied to the reference resistor Rref via the operational amplifier A. The reference resistor Rref generates the reference current Iref corresponding to the reference voltage Vref2 applied. The reference current Iref is inputted to the current mirror circuit 12 as an input current. An output current corresponding to the reference current Iref is outputted from the drain of the MOS transistor Q2 on the output side of the current mirror circuit 12.

As described above, the reference voltage generating circuit 20 can set the reference voltage Vref2 to a micro value. Thus, it is possible to generate the micro reference current Iref while suppressing and preventing an increase in a value of the resistance of the reference resistor Rref. Since it is possible to set a value of the resistance of the reference resistor Rref small, even if a resistance element having the resistance of the reference resistor Rref is formed using polysilicon, a temperature characteristic of which is satisfactory but a sheet resistance of which is relatively small, an increase in an area of the resistance element on a semiconductor substrate is prevented. This makes it possible to cut down a chip size and cost.

Each of the reference voltage generating circuits according to the invention explained by means of the embodiments includes: two voltage sources that generate predetermined voltages, respectively; a voltage dividing circuit that is connected between the two voltage sources, periodically divides a voltage generated between both the voltage sources, and outputs a divided voltage from a divided voltage output terminal; an output capacitor, one terminal of which is connected to the divided voltage output terminal and a reference voltage output terminal; a charging switch inserted between the output capacitor and the divided voltage output terminal; and a charge control circuit that turns on the charging switch in association with the output of the divided voltage of the voltage dividing circuit and charges the output capacitor. The reference voltage generating circuit outputs a reference voltage corresponding to the divided voltage from the reference voltage output terminal.

The reference voltage generating circuit according to the invention explained by means of the first embodiment includes: two voltage sources that generate predetermined voltages, respectively; a current path that includes a first resistor and a second resistor connected in series to each other between the two voltage sources; a bias current control circuit that periodically applies ON/OFF control to a bias current flowing through the current path; an output capacitor, one terminal of which is connected to a connection point of the first resistor and the second resistor and a reference voltage output terminal; a charging switch inserted between the output capacitor and the connection point; and a charge control circuit that turns on the charging switch in association with the ON control of the bias current and controls charging of the output capacitor. The reference voltage generating circuit outputs a reference voltage from the reference voltage output terminal.

An example of the bias current control circuit includes the switching element Q3 and the control circuit 16 in the embodiment. The reference voltage generating circuit 10 in the embodiment includes: the regulator 14 and the ground GND serving as two reference power supplies that generate predetermined voltages, respectively; a current path that includes the first resistor R1 and the second resistor R2 connected in series to each other between the two reference power supplies; the current path switch Q3 inserted in series in the current path; a current path control circuit that periodically applies connection and disconnection control to the current path switch Q3; the capacitor C, one terminal of which is connected to the connection point P of the first resistor R1 and the second resistor R2 and a reference voltage output terminal; the charging switch Q4 inserted between the capacitor C and the connection point P; and a charge control circuit that periodically applies connection and disconnection control to the charging switch Q4 in association with the connection and disconnection control of the current path switch Q3. The reference voltage generating circuit 10 outputs a reference voltage from the reference voltage output terminal.

In the first embodiment, the current path switch and the charging switch are constituted by the MOS transistors Q3 and Q4, respectively. The control circuit 16, which serves as the current path control circuit and the charge control circuit, supplies a common clock signal to the gate terminals of the respective MOS transistors Q3 and Q4 and applies ON/OFF control to conduction of the respective MOS transistors Q3 and Q4.

The charge control circuit may turn on the charging switch only in a charging period that is set to be included in a period in which the current path switch is on.

The reference voltage generating circuit according to the invention explained by means of the second embodiment includes: two voltage sources that generate predetermined voltages, respectively; plural element capacitors; a group of organizing switches that are capable of selectively forming a series constitution in which the plural element capacitors are connected in series to one another between the two voltage sources and a parallel constitution in which the plural element capacitors are connected in parallel to one another between one of the voltage sources and a junction point; a constitution control circuit that controls the group of organizing switches and periodically switches the series constitution and the parallel constitution; an output capacitor, one terminal of which is connected to the junction point and a reference voltage output terminal; a charging switch inserted between the output capacitor and the junction point; and a charge control circuit that turns on the charging switch in association with the formation of the parallel constitution and controls charging of the output capacitor. The reference voltage generating circuit outputs a reference voltage from the reference voltage output terminal.

The organizing switches and the charging switch may be constituted by transistors, respectively.

The reference current generating circuit according to the invention uses the reference voltage generating circuit. The reference current generating circuit includes an impedance converter amplifier that is inputted with the reference voltage from the reference voltage output terminal and the current mirror circuit 12 connected to an output terminal of the impedance converter amplifier. The current mirror circuit 12 includes the reference resistor Rref that sets an input current to the current mirror circuit according to a reference voltage applied to one terminal thereof. The current mirror circuit 12 is applied with the reference voltage Vref2 at the one terminal and outputs the reference current Iref corresponding to an output current of the current mirror circuit 12.

In the embodiment, the impedance converter amplifier is constituted by the operational amplifier A. A first input terminal of the operational amplifier A is connected to the reference voltage output terminal of the reference voltage generating circuit 10. A second input terminal of the operational amplifier A is connected to the one terminal of the reference resistor Rref. An output terminal of the operational amplifier A is connected to a current control terminal of the input transistor Q1 that is connected to the reference resistor and constitutes the current mirror circuit 12.

According to the invention, a micro voltage is generated by dividing a voltage between voltage sources at both ends with a voltage dividing circuit. The voltage dividing circuit only feeds an electric current to a current path intermittently or the voltage dividing circuit uses a capacitor. Consequently, a reduction in power consumption is realized. The micro voltage generated by the voltage dividing circuit is held by an output capacitor and used as a reference voltage. It is possible to generate a micro reference current while suppressing an increase in a reference resistance by using the micro reference voltage.

What is claimed is:

1. A reference voltage generating circuit comprising:
two voltage sources that generate predetermined voltages, respectively;
a voltage dividing circuit that is connected between the two voltage sources, periodically divides a voltage generated between both the voltage sources, and outputs a divided voltage from a divided voltage output terminal;
an output capacitor, one terminal of which is connected to the divided voltage output terminal and a reference voltage output terminal;
a charging switch inserted between the output capacitor and the divided voltage output terminal; and
a charge control circuit that turns on the charging switch in association with the output of the divided voltage of the voltage dividing circuit and charges the output capacitor,
wherein the reference voltage generating circuit outputs a reference voltage corresponding to the divided voltage from the reference voltage output terminal.

2. The reference voltage generating circuit according to claim 1, wherein
the voltage dividing circuit includes:
a current path that includes a first resistor and a second resistor connected in series to each other between the two voltage sources; and
a bias current control circuit that periodically applies ON/OFF control to a bias current flowing through the current path,
one terminal of the output capacitor is connected to a connection point of the first resistor and the second resistor and a reference voltage output terminal, the connection point serving as the divided voltage output terminal, and
the charge control circuit turns on the charging switch in association with the ON control of the bias current and controls charging of the output capacitor.

3. The reference voltage generating circuit according to claim 1, wherein
the voltage dividing circuit includes:
a current path that includes a first resistor and a second resistor connected in series to each other between the two voltage sources;
a current path switch inserted in series in the current path; and
a current path control circuit that periodically applies ON/OFF control to the current path switch,
one terminal of the output capacitor is connected to a connection point of the first resistor and the second resistor and a reference voltage output terminal, the connection point serving as the divided voltage output terminal, and
the charge control circuit turns on the charging switch in association with the ON control of the current path switch and controls charging of the output capacitor.

4. The reference voltage generating circuit according to claim 3, wherein the current path switch and the charging switch are constituted by transistors, respectively.

5. The reference voltage generating circuit according to claim 4, wherein the current path control circuit and the charge control circuit supply a common clock signal to gate terminals of the respective transistors and apply ON/OFF control to conduction of the respective transistors.

6. The reference voltage generating circuit according to claim 3, wherein the charge control circuit turns on the charging switch only in a charging period that is set to be included in a period in which the current path switch is on.

7. The reference voltage generating circuit according to claim 1, wherein
the voltage dividing circuit includes:
plural element capacitors;
a group of organizing switches that are capable of selectively forming a series constitution in which the plural element capacitors are connected in series to one another between the two voltage sources and a parallel constitution in which the plural element capacitors are connected in parallel to one another between one of the voltage sources and a junction point; and
a constitution control circuit that controls the group of organizing switches and periodically switches the series constitution and the parallel constitution,
one terminal of the output capacitor is connected to the junction point and a reference voltage output terminal, the junction point serving as the divided voltage output terminal, and
the charge control circuit turns on the charging switch in association with the formation of the parallel constitution and controls charging of the output capacitor.

8. The reference voltage generating circuit according to claim 7, wherein the organizing switches and the charging switch are constituted by transistors, respectively.

9. A reference current generating circuit that uses the reference voltage generating circuit according to claim 1, the reference current generating circuit comprising:
an impedance converter amplifier that is inputted with the reference voltage from the reference voltage output terminal; and
a current mirror circuit connected to an output terminal of the impedance converter amplifier,
wherein
the current mirror circuit includes a reference resistor that is applied with the reference voltage at one terminal thereof and sets an input current to the current mirror circuit according to the reference voltage, and
the reference current generating circuit outputs a reference current corresponding to an output current of the current mirror circuit.

10. The reference current generating circuit according to claim 9, wherein
the impedance converter amplifier consists of an operational amplifier, and
a first input terminal of the operational amplifier is connected to the reference voltage output terminal, a second input terminal of the operational amplifier is connected to the one terminal of the reference resistor, and an output terminal of the operational amplifier is connected to a current control terminal of an input transistor that is connected to the reference resistor and constitutes the current mirror circuit.
